(19) United States
(12) Patent Application Publication
(10) Pub. No.: US 2016/0080336 A1
(43) Pub. Date: Mar. 17, 2016

(54) Key Usage Detection

(71) Applicants: Mark Ryan, Birmingham (GB); Jiangshan Yu, Birmingham (GB)

(72) Inventors: Mark Ryan, Birmingham (GB); Jiangshan Yu, Birmingham (GB)

(21) Appl. No.: 14/852,342

(22) Filed: Sep. 11, 2015

(30) Foreign Application Priority Data
Sep. 12, 2014 (GB) 1416188.9

(51) Int. Cl. H04L 29/06

(52) U.S. Cl. CPC H04L 63/061; H04L 63/0435; H04L 63/123

(57) ABSTRACT

Key usage detection, and in particular, methods and systems for a recipient of an encrypted message to detect usage of the recipient's secret key.

This application claims priority under 35 U.S.C. §119 and is entitled to the filing date of UK patent application GB 1416188.9 filed on Sep. 12, 2014. The contents of the aforementioned application are incorporated by reference herein.

The present disclosure relates to key usage detection, and in particular to methods and systems for a recipient of an encrypted message to detect usage of the recipient's secret key.

In cryptography, encryption is an important way to ensure the confidentiality of digital messages exchanged between a sender and recipient. However, there is a gap between the assumption that a secret key is only known by the owner, and the fact that some party (e.g. an attacker) may have a way to gain access to the secret key. The security of existing systems cannot be guaranteed if the secret key is abused after being exposed to other parties.

Currently there are no effective methods to detect improper usage of a decryption key. In the setting of symmetric key encryption, the communication parties share the same secret key for encryption and decryption, and the key owners cannot detect the condition that the key is compromised. Similarly, in the setting of public key encryption, the key owner who has a pair of public key and private key for message encryption and decryption, respectively, cannot detect when his private key has been compromised. So, in both cases, the secret key owner is not prompted to revoke the comprised secret key or take other actions. Hence, the security that the system guarantees is broken until the secret key has expired. However even when a key is expired or revoked, the new key may also become compromised.

For example, if someone's decryption key is compromised by an attacker, and the attacker has a copy of the ciphertext, then the attacker can sneakily decrypt the ciphertext by using the compromised key. In this case, the victim has no way to detect it. For example, if a user Alice wants to send a private message to a domain server Bob through the transport layer security (TLS) protocol, then Alice needs to obtain Bob's public key certificate, and encrypt and send a session key establishment message to Bob to generate a session key. Here, if an attacker Eve can somehow compromise Bob's private key corresponding to the certificate Alice obtained, then she is able to block and decrypt the cipher text from Alice, and play man-in-the-middle attacks without being detected.

A system to detect unauthorized usage of a secret key would therefore provide a better security guarantee when exchanging digital messages.

According to a first aspect of the disclosure there is provided a method for a recipient of an encrypted message to detect usage of a first key belonging to the recipient wherein:
a sender and the recipient establish a second key using the first key;
the recipient publishes a commitment relating to the second key in a log;
the sender verifies the published commitment; and
the recipient monitors the log to detect usage of the first key.

The recipient may publish a commitment relating to the encryption key before, during, or after the establishment of the encryption key. Similarly, the sender may verify the published commitment before, during or after the establishment of the encryption key.

A commitment is a kind of information binding. It allows a party to commit to a chosen value (or statement), ensuring that this party is not able to change the value (or statement) after s/he has committed to it.

Optionally, the published commitment comprises a commitment of the recipient's key exchange contribution to the second key, a commitment of the sender's key exchange contribution to the second key, or a commitment of the second key.

Optionally, the recipient maintains his own record of the log and compares the log with his own record.

This comparison may be performed on a periodic basis.

An alert may be generated if the comparison reveals a discrepancy between the recipient's record and the information held in the log, so that the recipient can revoke his secret key.

Optionally, the recipient has a key pair comprising the first key and a third key and according to the method:
the recipient commits to information relating to the second key with his first key; and
the sender uses the third key to verify the commitment of the recipient on the committed information.

Optionally, the recipient's commitment of information relating to the second key comprises a digital signature or other proof of knowledge.

Two keys form a key pair if they are mathematically linked such that a message committed or signed with one of the keys can be verified with the other.

Optionally, the information relating to the second key committed by the recipient comprises one or more of: the recipient's key exchange contribution to the second key or a commitment thereof, a commitment of the second key, the sender's key exchange contribution to the second key or a commitment thereof.

Optionally, the first key is a secret key.

Optionally, the first key is a key shared between sender and recipient, and according to the method: the recipient authenticates information related to the second key with the first key; and the sender uses the first key to verify the authenticity of the information.

Optionally, the first key is a symmetric key.

Optionally, the sender and recipient establish the second key using a Diffie-Hellman key exchange protocol.

Optionally, parties comprising one or more recipients and one or more senders employ a gossip protocol to verify that the parties are being shown the same version of the log.

Optionally, a sender obtains a key establishment message from a maintainer of the log.

Optionally, the recipient generates a set of key establishment messages, commits to each of them, and publishes them in the log.

Optionally, the recipient generates a set of key establishment messages, commits to information relating to the set of key establishment messages and publishes the commitment in the log.

Optionally, the commitments are digital signatures or other proof of knowledge.

Optionally, the key establishment message(s) are for the establishment of the second key.

Optionally, the second key is an encryption key.

Optionally, the third key is a verification key.

Optionally, the log is an append-only log.

A log is append-only if the only operation it supports is appending data. In particular, it does not support modifying or removing data.

Optionally, the log comprises a tree data structure.

Optionally, the log comprises a first data structure in which items are ordered chronologically and a second data structure in which items are ordered by an attribute of the items.

Optionally, the log comprises a plurality of said second data structures. The plurality of second data structures may be ordered by different attributes.

Optionally in the second data structure the items are ordered lexicographically according to user identifier.

Optionally, one or more of the tree structures comprises a Merkle tree.

Optionally, the log is public.

Optionally, the addressable public who can access the log comprise a set of users who are provided with permissions to access the log.

The set of users may, for example, be members of an organisation or those within a specific network or sub-network.

Alternatively, the addressable public who can access the log comprises the general public.

Optionally, a single log is maintained for multiple users.

Optionally, the recipient and the sender exchange an encrypted digital message.

According to a second aspect of the disclosure there is provided a method of exchanging an encrypted digital message between a sender and a recipient that holds a first key, wherein:
the sender and the recipient establish a second key using the first key;
the recipient publishes a commitment relating to the second key in a log;
the sender verifies the published commitment; and
the recipient monitors the log to detect usage of the first key.

All the features of the first aspect as mentioned above may also be employed in the method of the second aspect.

According to a third aspect of the disclosure there is provided a system comprising
a first key held by a recipient of an encrypted message;
a log; and
a computer program product comprising instructions that, when executed by a computer, implement a protocol for the recipient of an encrypted message to detect usage of the first key wherein, according to said protocol:
a sender and the recipient establish a second key using the first key,
the recipient publishes a commitment relating to the second key in a log,
the sender verifies the published commitment, and
the recipient monitors the log to detect usage of the first key.

The computer program product may comprise instructions for carrying out or implementing all the features of the first aspect and second aspects as mentioned above.

According to a fourth aspect of the disclosure there is provided a computer program product comprising instructions that when executed by a computer, enable the computer to act as a recipient of an encrypted message in any of the first, second and third aspects.

According to a fifth aspect of the disclosure there is provided a computer program product comprising instructions that when executed by a computer, enable the computer to act as a sender of an encrypted message in any of the first, second and third aspects.

According to a sixth aspect of the disclosure there is provided a computer program product comprising instructions that when executed by a computer, enable the computer to act as a log in any of the first, second and third aspects.

According to a seventh aspect of the disclosure there is provided a method for storing and retrieving data in a database comprising providing a first data structure in which items are ordered chronologically and one or more second data structures in which items are ordered by an attribute of the items.

Optionally, the method comprises querying the first data structure to establish a proof that a later snapshot of the database is an extension of an earlier snapshot of the database.

Optionally, the method comprises querying the second data structure to establish a proof that a response to a database query is a complete response.

Optionally, the first and/or second data structures are tree data structures.

Optionally, the tree data structures are Merkle tree data structures.

Optionally, in the second data structure the items are ordered lexicographically according to user identifier.

Optionally, the data structures store digital signatures.

According to an eighth aspect of the disclosure there is provided database comprising a first data structure in which items are ordered chronologically and one or more second data structures in which items are ordered by an attribute of the items.

Optionally, the first and/or second data structures are tree data structures.

Optionally, the tree data structures are Merkle tree data structures.

Optionally, in the second data structure the items are ordered lexicographically according to user identifier.

Optionally, the data structures store digital signatures.

The computer program product may be stored on or transmitted as one or more instructions or code on a computer-readable medium. Computer-readable media includes both computer storage media and communication media including any medium that facilitates transfer of a computer program from one place to another. A storage media may be any available media that can be accessed by a computer. By way of example such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fibre optic cable, twisted pair, digital subscriber line (DSL), or wireless technologies such as infra-red, radio, and microwave, then the coaxial cable, fibre optic cable, twisted pair, DSL, or wireless technologies such as infra-red, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The instructions or code associated with a computer-readable medium of the computer program product may be executed by a computer, e.g., by one or more processors, such as one or more digital signal processors (DSPs), general purpose microprocessors, ASICs, FPGAs, or other equivalent integrated or discrete logic circuitry. A computer that executes the instructions may be or be part of any suitable form, including without limitation a personal desktop or laptop computer, a mobile device such as a smart phone or tablet.

The disclosure will be described below, by way of example only, with reference to the accompanying drawings, in which:

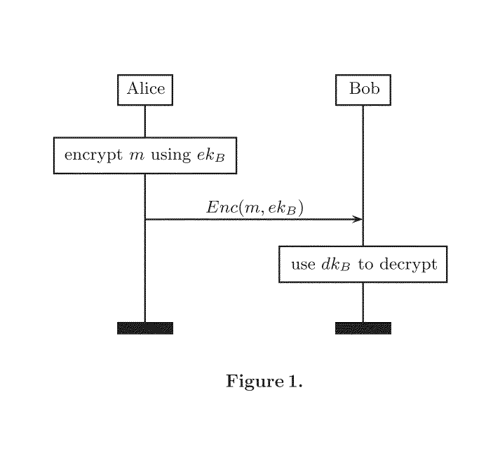

FIG. 1 illustrates an existing protocol for the exchange of a digital message, in which a sender, Alice, sends a recipient, Bob, a message m encrypted by using Bob's public key ek_{B};

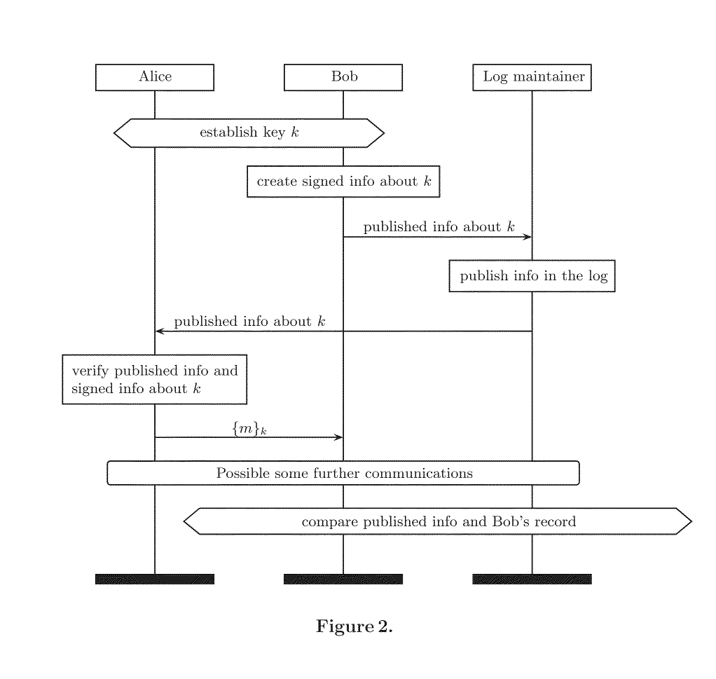

FIG. 2 illustrates an embodiment of a protocol for exchange of a message according to the disclosure;

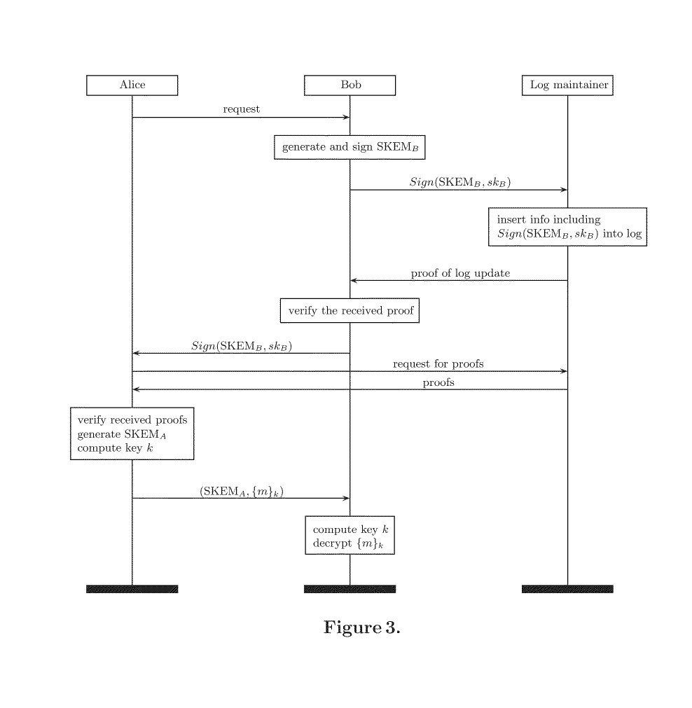

FIG. 3 shows the concept of a log update and secure communication phase in an aspect where the recipient, Bob, is online;

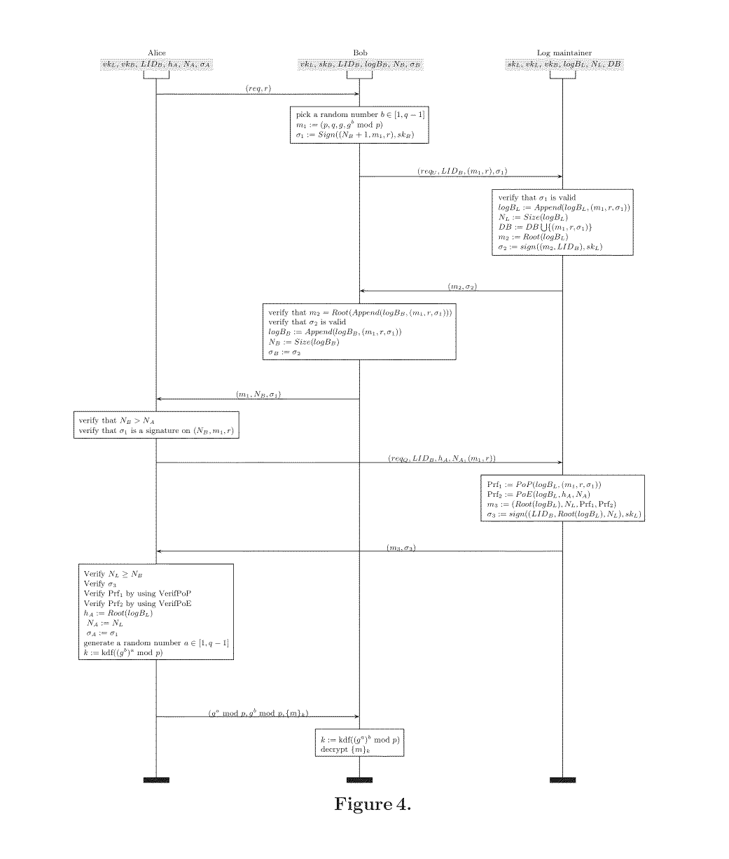

FIG. 4 shows further details of the log update and secure communication phases of FIG. 3;

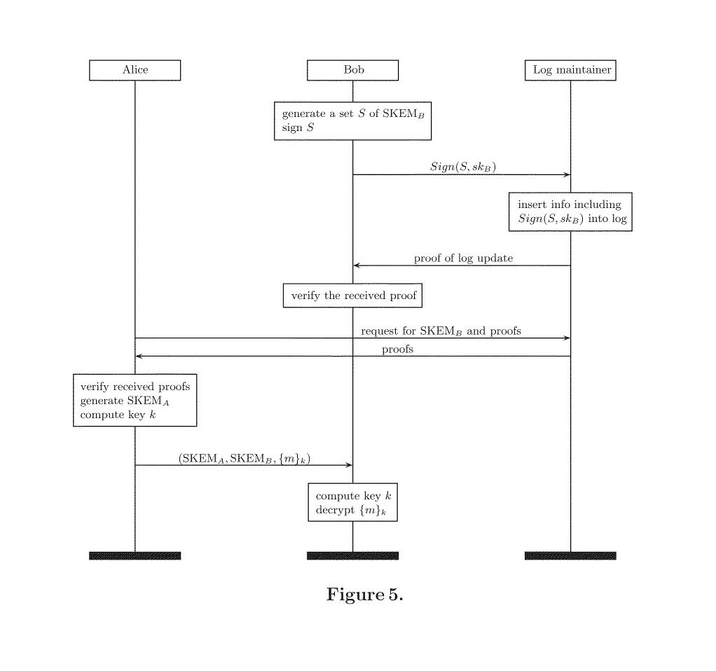

FIG. 5 shows an overview of a secure communication phase of a protocol where a recipient is offline;

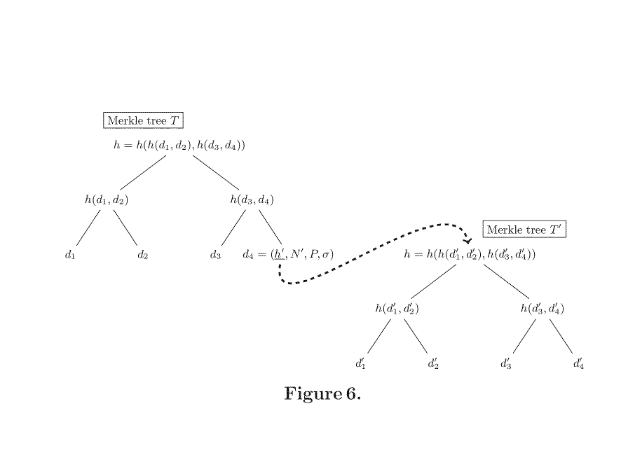

FIG. 6 shows an example of a public log structure according to the disclosure;

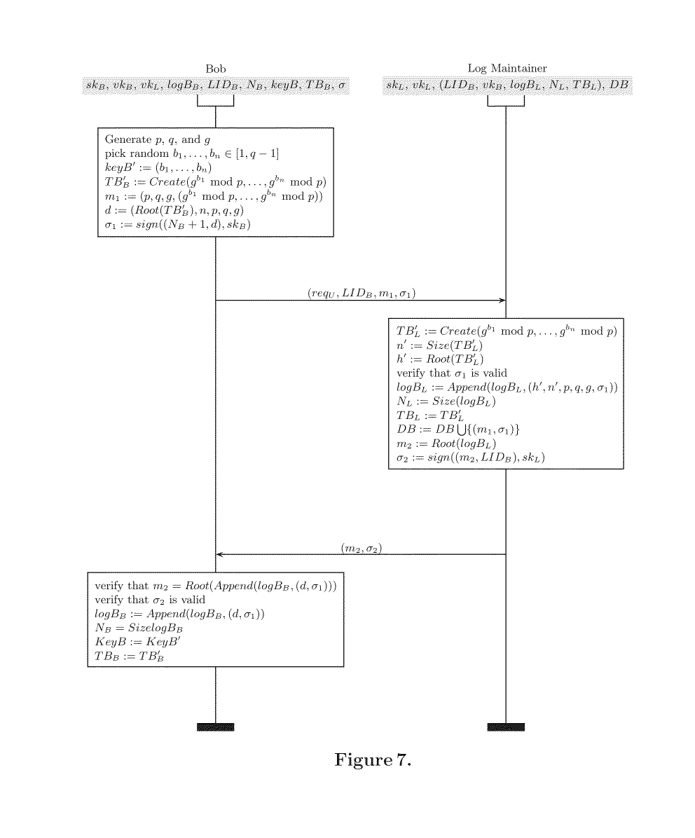

FIG. 7 shows a protocol for updating a public log;

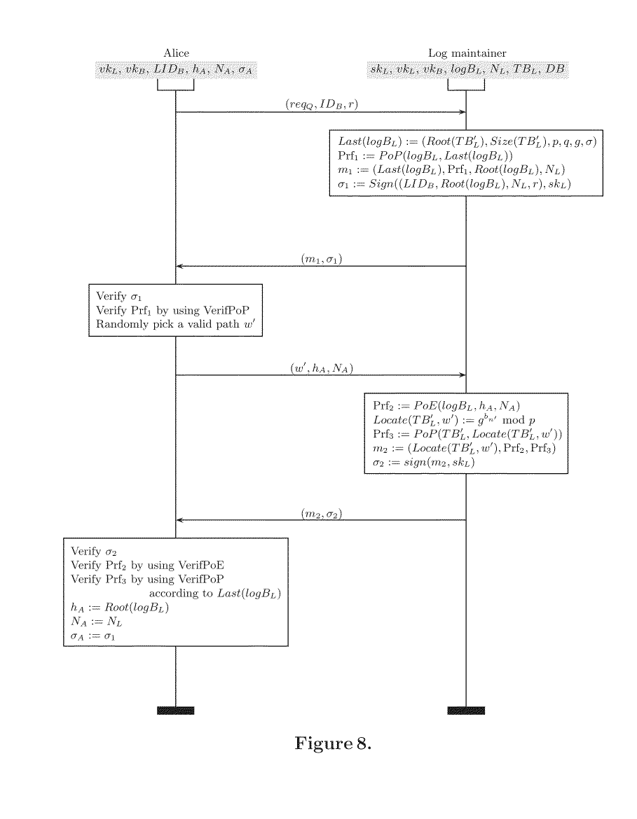

FIG. 8 shows a protocol of fetching an SKEM for Diffie-Hellman key establishment;

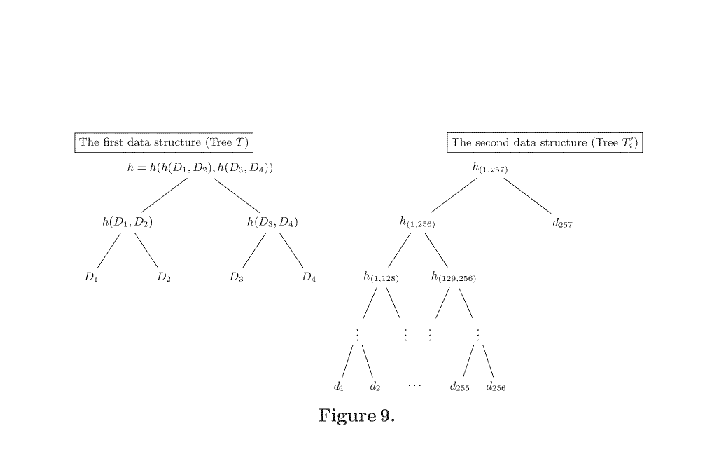

FIG. 9 shows an example of two data structures which may be used in a log for monitoring multiple keys; and

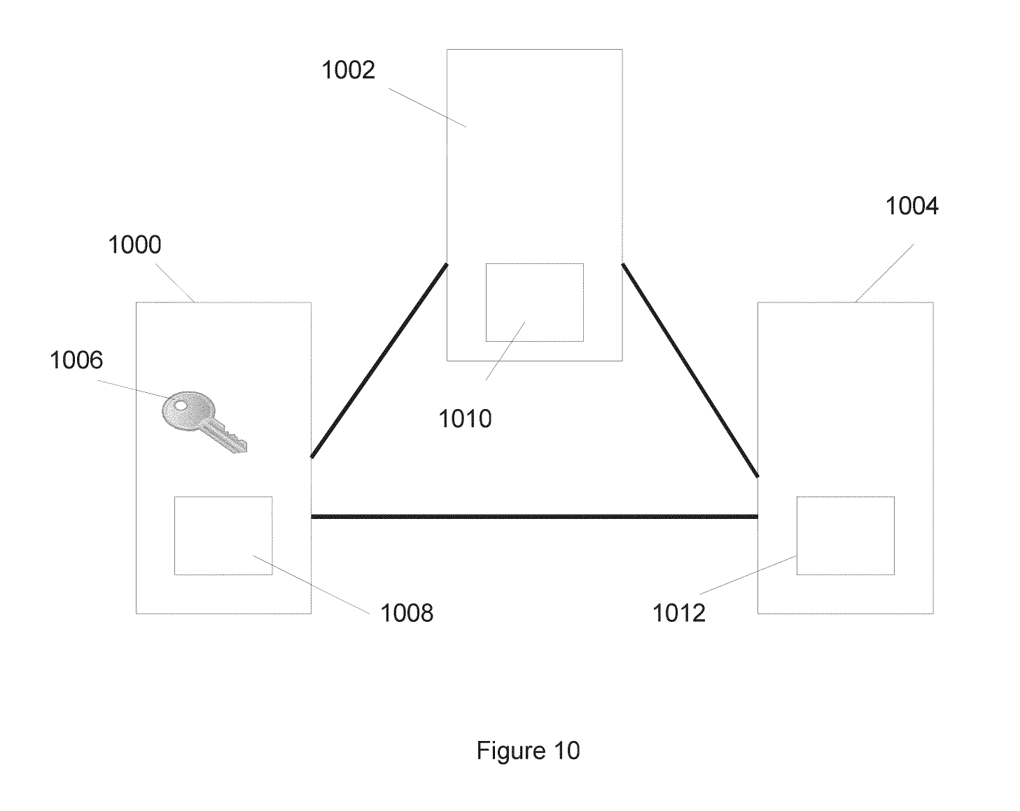

FIG. 10 shows an example of a system according to an embodiment of the disclosure.

Suppose that Alice wants to send a confidential message m to Bob. Suppose Bob has a public/private key pair for encryption; that is, he has a decryption key dk_{B} which is kept private, and an encryption key ek_{B} which is published.

According to the current state of the art and as illustrated in FIG. 1, Alice encrypts the message musing Bob's encryption key ek_{B}, creating a ciphertext. If only Bob has possession of dk_{B}, then only Bob can decrypt the ciphertext. However, if dk_{B} has become exposed to an attacker, the attacker can decrypt the ciphertext. Bob has no reliable way to be aware that this has happened.

According to the present disclosure, commitments about the usage of private keys are recorded in a log. This enables a key owner to monitor the usage of a key.

FIG. 2 illustrates an embodiment of a protocol for the exchange of a message according to the disclosure, in which a sender (Alice) sends a message to a recipient (Bob). Here, Bob uses a public/private key pair for signatures, that is, a signing key sk_{B} which is kept private, and a verification key vk_{B} which is published. The signing and verification keys are a key pair, that is, they are mathematically linked such that a message signed with one of the keys can be verified with the other.

Alice and Bob engage in a key establishment protocol to obtain a symmetric key k. The key establishment protocol may be any protocol that allows two parties to establish a shared secret key over an insecure communication channel. In a key exchange protocol, each party makes a contribution to the key, and they exchange their contributions to create a shared secret in such a way that each contribution influences the resulting secret, and the secret can only be computed by each of the parties. If properly done, this precludes undesired parties from forcing a key choice on the key exchanging parties.

One example is the Diffie-Hellman key exchange protocol. Here, Alice and Bob agree on a finite cyclic group G and a generating element g in G. (This is usually done long before the rest of the protocol, and g is assumed to be known by all attackers.) We will write the group G multiplicatively. Alice picks a random natural number a and sends g^{a} to Bob. Bob picks a random natural number b and sends g^{b} to Alice. Alice computes (g^{b})^{a}. Bob computes (g^{a})^{b}. Both Alice and Bob are now in possession of the group element g^{(ab)}, which can serve as the shared secret key. The values of (g^{b})^{a} and (g^{a})^{b} are the same because groups are power associative. Here, all powers are computed modulo p.

Another example of a key exchange protocol that can be used with the disclosure is the Needham-Schroeder-Lowe protocol.

Before, during or after the establishment of k, Bob publishes a commitment relating to k in a public log. This commitment may be referred to as “published information”. Bob also keeps his own record of the published information.

A commitment of data is a version of the data that has been modified in such a way that the data itself is hidden, but can be revealed later by the committing party and where the party receiving the commitment can verify that the data is indeed the data which was committed.

The commitment relating to k may be any suitable public or private commitment that meets these criteria, and may be of any data directly or indirectly linked to k. For example, the commitment relating to k could be a commitment of k itself, a commitment of Alice's contribution for key establishment, a commitment of Bob's contribution for key establishment, a commitment of any combination of k, Alice's contribution for key establishment, Bob's contribution for key establishment and of their commitments.

The commitment may also be generated by any suitable method. For example, ĝa (a generator g to the power of a random number a as used in the Diffie-Hellman key exchange) can be treated as a commitment of some (hidden and private) value a which may or may not be revealed afterwards. Another example of a commitment is a signature on some value b, so the signature is the commitment of a (possibly public) value b. One more example, h(c), is a commitment of value c, where h is a secure hash function and c can be a public or a private value. It will be appreciated that there are many other methods of generating commitments.

To give some examples, the published information may comprise Bob's Diffie-Hellman key exchange contribution to k, Bob's signature on Alice's Diffie-Hellman contribution to k, or a commitment of k.

Also, before, during or after the establishment of k, Bob may sign some information related to k using sk_{B}. This can be referred to as “signed information”. The information related to k which is signed could be any data directly or indirectly linked to k, including a commitment relating to k as described above. The signed information may the same as the published information, but could be different.

To give some examples, the signed information may comprise Bob's signature on Bob's Diffie-Hellman contribution to k, or Bob's signature on a commitment of k.

Alice uses Bob's verification key vk_{B} to verify Bob's signature on the signed information.

Alice also retrieves the published information from the public log and verifies it using the verification key of the log maintainer. If Alice's verifications of Bob's signature on the signed information and of the published information from the public log succeed, Alice uses the key k to encrypt m and sends the ciphertext to Bob.

At some later time, Bob can verify that the information published in the log agrees with his own record of published information. This verification may be carried out on a periodic basis and may be after several communications between Bob and Alice.

If Bob's signing key sk_{B}becomes exposed to an attacker, the attacker can sign information about symmetric keys and publish information about them in the log. Alice might use those keys to send confidential messages to Bob, and the attacker might be able to decrypt them. The present disclosure allows Bob to detect that this has happened, because his verification that the published information agrees with his own record will fail. Furthermore, the protocol of the present disclosure may be aborted if verifications by Alice or the log maintainer fail.

The log is maintained by a party known as the log maintainer. The log maintainer has responsibility for providing the log the relevant public, and for receiving and processing requests for log creation and update, carrying out various validations and serving log information to requesting parties. The log maintainer also has a private signing key sk_{L} and a public verification key vk_{L}.

The public who can access the log may comprise a single party apart from and including Alice and Bob; or the public may comprise all actors within an organisation. Alternatively the public may comprise the general public without restriction.

An attacker should not be able to remove information from the log. To achieve this, the log may be an append-only data structure.

It is also advantageous for users of the log (including Bob, above) to securely verify that no information has been deleted from the log. For this purpose, the log can be organised as a Merkle tree in which data is inserted by extending the tree to the right. This construction allows the log maintainer to provide efficient proofs that the log is being maintained in an append-only manner.

It is also advantageous if a maintainer of the log cannot maintain two different versions of the log which it shows to different sets of users. Gossip protocols may be used to ensure this, whereby parties can exchange and distribute the digest of the log to verify the consistency of the log they have seen.

The public log can be organised using a Merkle tree. A Merkle tree is a tree in which every node is labelled with the hash of the labels of its child nodes, and possibly some other values. Suppose a node has children with hash values h₁, . . . , hₙ, and has data d. Then the hash value of the node is the hash of h₁, . . . , hₙ, d. Merkle trees allow efficient proofs that they contain certain data. To prove that a certain data item d is part of a Merkle tree requires an amount of data proportional to the log of the number of nodes of the tree. This contrasts with hash lists, where the amount of data required for such a proof is proportional to the number of nodes. A Merkle tree supports the following methods:

| Method | Input | Output |
|---|---|---|
| Create | (d₁, . . . , dₙ) | A Merkle tree whose leaves are d₁, . . . , dₙ |
| Append | (T, d) | The Merkle tree Tappended byd |
| Size | T | The size of the Merkle treeT |
| Root | T | The root value of the Merkle treeT |
| Last | T | The data stored in the rightmost side leaf of Merkle treeT |
| Locate | (T, w) | The data stored in the leaf with path win the Merkle |
| | | treeT |
| PoP | (T, d) | The proof Prf_{PoP}that dis inT |
| VerifPoP | (d, h, N, Prf_{PoP}) | A Boolean value indicating whether the proof |
| | | Prf_{PoP}that data dis in the Merkle tree whose root value |
| | | is hand size is Nis valid. |
| PoE | (T, h′, N′) | The proof Prf_{PoE}that a Merkle tree Tis an extension of |
| | | another Merkle tree whose root value is h′and size isN′ |
| VerifPoE | (h, N, h′, N′, Prf_{PoE}) | A Boolean value indicates whether the proof Prf_{PoE}that |
| | | a Merkle tree with root value hand size Nis an |
| | | extension of another Merkle tree with root value h′and |
| | | size N′is valid. |

The verifications of PoP (proof of presence) and PoE (proof of extension), namely, VerifPoP(.) and VerifPoE(.), are used by the verifying user; the remaining methods are used by the tree maintainer.

Data stored in a Merkle tree structure can be ordered in different ways. One example data structure is a Merkle tree structure in which items are stored in chronological order and by which proofs of chronological extension of the data structure can be furnished in a time of the order of the logarithm of its size.

Other Merkle tree structures may be ordered by attributes of the data. They are used to allow efficient proofs that a certain set of data is the whole set satisfying a certain query (associated to the attribute). One example of which is a hash tree in which items are only stored at leaves and ordered according to some attribute of the data. Another example of possible ordered data structure is a hash tree structure, in which items are stored in both leaf node and non-leaf node, and ordered according to some attribute of the data (similar to a binary search tree).

There are other data structure (e.g. hash lists or hash chains) besides Merkle trees that can be used which enable users to securely verify that no information has been deleted from the log, but they are less efficient.

There may also be randomized checking to ensure that the data structures are maintained consistently. For example, if a log is organised by using two data structures, then users may randomly select some data stored in a data structure and verify the presence of the same data in the other data structure. If all data are eventually selected and verified by users, then the data structures are maintained consistently.

A communication protocol according to the disclosure will now be explained in more detail. Let Alice and Bob be two communication parties. In particular, we consider that Alice is always the party who starts the communication. In other words, we consider that Alice wants to send a private message m to Bob.

In addition, we assume that Bob and the log maintainer respectively have a pair of private/public keys (sk_{B}/vk_{B}) and (sk_{L}, vk_{L}) for signing/verification; Alice has obtained an authentic copy of vk_{B} and vk_{L}; and Bob and the log maintainer have an authentic copy of each other's public key.

In addition, we assume that the protocols use the Diffie-Hellman key exchange, although other key exchange protocols may be used. Moreover, we assume that Bob generates a large prime number p and a relatively small prime number q with q |(p−1), and a generator g of a subgroup G of [symbol] ₚ* of order q( [symbol] ₚ* is the cyclic group of order (p−1), which contains {1, 2, . . . , p−1}. The * means that all elements in Zₚ have a multiplicative inverse. G is a cyclic subgroup of [symbol] ₚ*). This setting is an example among many other possibilities that will be used in this document, although other settings are possible, such as elliptic curve Diffie-Hellman key exchange or key establishment using RSA cryptography.

According to one aspect of the disclosure, the recipient, Bob, will be online. This aspect may be useful in the scenario where the two communicating parties are synchronous and online, such as online banking. There are three phases, namely log initialisation, log update and secure communication, and log monitoring.

In a log initialisation phase, Bob creates a log log B_{L} with the log maintainer, and maintains his own copy log B_{B}. To do so, Bob first creates an empty log log B_{B}=Create(φ), then sends a registration request (req, ID_{B}, nonce, σ) to the log maintainer, where ID_{B} is the identity of Bob and σ=Sign((req, ID_{B}, nonce), sk_{B}) is a signature on the request (req, ID_{B}, nonce) under signing key sk_{B}.

After receiving the request, the log maintainer verifies the signature using Bob's verification key vk_{B}. If the signature is valid and there is no existing log for ID_{B} under the same signing key, then she creates an empty log log B_{L}=Create(θ) with log identity LID_{B} for Bob, stores the request ((req, ID_{B}, nonce), σ) in her database DB, signs the confirmation (LID_{B}, ID_{B}, nonce) with her signing key sk_{L}, and sends the signed confirmation to Bob.

FIG. 3 shows a concept of a log update and secure communication phase in an aspect where the recipient, Bob, is online. Here, Bob interacts with the log maintainer to publish a commitment about the established key k during the key establishment.

Alice starts the communication by sending a request to Bob, who will generate a symmetric key establishment message (SKEM), sign it, publish it in the log, and send it to Alice. Alice also receives proofs about SKEM from the log maintainer, and if all related proofs are valid, Alice encrypts message m by using the established key k and sends it to Bob who can then decrypt it.

The log update and secure communication phase of FIG. 3 is presented in more detail in FIG. 4. We assume that Bob has stored a previous version of his log log B_{B} of size N_{B} and identity LID_{B}, and a signature σ_{B} from the log maintainer in the previous session of communication between Alice and Bob; the log maintainer has maintained her copy log B_{L} of Bob's log B_{B}, the size of log B_{L} is denoted N_{L}; and Alice has stored Bob's log identity LID_{B}, a hash value h_{A}, an integer N_{A}, and a signature σ_{A}=Sign((LID_{B}, h_{A}, N_{A}), sk_{L}) obtained from the log maintainer in the previous session. Here, h_{A} and N_{A} are respectively the root hash value and the size of Bob's log in that session.

If Alice wants to send a private message to Bob, she needs to start the key establishment protocol by sending a request req with a random number r to Bob. Upon receiving the request, Bob generates g^{b}modp, where g is a generator as mentioned above, p is a relatively large prime number as explained above, b is a random number in [1, q−1] and q is a relatively small prime number as mentioned above.

Now Bob sends (req_{U}, LID_{B}, (m₁, r), σ₁) to the log maintainer, where req_{U} is the update request, m₁=(p, q, g, g^{b}modp) and σ₁=Sign((N_{B}+1, m₁, r), sk_{B}). m₁ is a message comprising settings p, q, g for the key exchange, and Bob's contribution to the key exchange, g^{b} mod p.

After receiving the request, the log maintainer verifies whether σ₁ is a valid signature on (N_{L}+1, m₁, r) (using Bob's verification key) and is signed by the owner (i.e. Bob) of LID_{B} (by checking if the log ID Bob sends matches with her record according to the identity of the issuer of σ₁). If the signature is valid and signed by Bob, then the log maintainer updates the log log B_{L} by letting log B_{L}=Append(log B_{L}, (m₁, r, σ₁)), replaces N_{L} with Size(log B_{L}), stores (m₁, r, σ₁) in her database DB. The data (m₁, r, σ₁) forms “published information” being a commitment relating to the symmetric key k which is to be established.

The log maintainer sends (m₂, σ₂) to Bob as the evidence of success of the log update, where message m₂ is the root value of the log maintainer's log B_{L}, m₂=Root(log B_{L}) and signature σ₂ with the log maintainer's private signing key sk_{L} on m₂ and Bob's log ID, σ₂=Sign((m₂, LID_{B}), sk_{L}).

On the other hand, if the signature is not valid and/or is not signed by Bob, then the log maintainer does not update the log and will not send Bob evidence of success of the log update. The protocol can be terminated at this point, with suitably informative error messages being sent back to Alice and/or to Bob.

Once Bob receives (m₂, σ₂) he should check if the size of the log according to his own records matches that recorded by the log maintainer, and verify the validity of the log maintainer's signature using the log maintainer's verification key vk_{L} i.e. checking m₂=Root(Append(log B_{B}, (m₁, r, σ₁))), and verifying the validity of σ₂. If the logs match and the signature is valid, then he updates his local copy by letting log B_{B}=Append(log B_{B}, (m₁, r, σ₁)), and replaces N_{B} with Size(log B_{B}), and replaces σ_{B} with σ₂. Bob then sends (m₁, N_{B}, σ₁) to Alice.

On the other hand, if the logs do not match and/or the signature is not valid, then Bob will not update his local copy of the log and will not send (m₁, N_{B}, σ₁) to Alice. The protocol can be terminated at this point, with suitably informative error messages being sent back to Alice and/or to Bob.

After Alice receives (m₁, N_{B}, σ₁) from Bob, she checks whether N_{B}>N_{A} to confirm that the log has been updated since previous communication, and whether σ₁ is a valid signature on (N_{B}, m₁, r). If N_{B}>N_{A} is true and σ₁ is a valid signature, then she sends a request message (reg_{Q}, LID_{B}, h_{A}, N_{A}, (m₁, r)) to the log maintainer.

The log maintainer should generate the proof Prf₁ that the leaf containing (m₁, r, σ₁) is in the log B_{L}, and proof Prf₂ that the current log log B_{L} is an extension of the log whose root hash value is h_{A} and size is N_{A}, then sends message m₃ and signature σ₃ to Alice, where m₃₌(Root(log B_{L}), N_{L}, Prf₁, Prf₂) and σ₃=sign((LID_{B}, Root(log B_{L}), N_{L}), sk_{L}).

If N_{L}≧N_{B} and σ₃ is a valid signature and proofs are valid, then Alice replaces h_{A} with Root(log B_{L}), N_{A} with N_{L}, and σ_{A} with σ₁, then generates a random number a ∈[1, q−1], encrypts message m by using symmetric key k=kdf((g^{b})^{a}modp), where kdf is a suitable key derivation function and sends (g^{a}modp, g^{b}modp, {m}ₖ) to Bob who can reconstruct k=kdf((g^{a})^{b}modp), and decrypt {m}ₖ (the message m encrypted with the key k). A key derivation function (KDF) derives one or more secret keys from a secret value such as a master key or other known information such as a password or passphrase using a pseudo-random function. An example of a KDF is a hash message authentication code (HMAC)-based Extract-and-Expand Key Derivation Function (HKDF), although any suitable KDF can be used in the present disclosure.

Key owners need to monitor whether the log maintainer has published the same hash value of the log as the one the key owner has. In addition, all participants can verify that they have seen the same log through gossip protocols. For example, if both Alice and Charlie have respectively stored (h_{A}, N_{A}, σ_{A}) and (h_{C}, N_{C}, σ_{C}) which are snapshots of the same log of a given key owner, then if N_{A}=N_{C}, they should check whether h_{A}=h_{C}; otherwise they should query the log corresponding maintainer for the proof that the log represented by h_{A}of size N_{A}is an extension of the log represented by h_{C} of size N_{C} if N_{A}>N_{C}, or they should query the log corresponding maintainer for the proof that the log represented by h_{C} of size N_{C} is an extension of the log represented by h_{A} of size N_{A} if N_{A}<N_{C}.

According to another aspect of the disclosure, the recipient, Bob, may be offline when Alice wants to send a message to him. This corresponds to asynchronous communication, as seen for example in e-mail.

In the previous aspect, Alice obtains a symmetric key establishment message (SKEM) from Bob directly. However when Bob is offline, she may obtain the SKEM from the log maintainer. Bob will pre-generate a set of key establishment messages, then ask some party (e.g. the log maintainer) to store them, and publish commitments of them in the public log. By doing so, if Alice wants to send Bob a message, then she can obtain one of Bob's key establishment messages by asking the log maintainer. Thus, Alice can build the symmetric key and use the key even when Bob is offline. FIG. 5 shows an overview of this aspect.

A log is initialised in the same manner as described above for the aspect where Bob is online.

According to one embodiment, Bob may generate a set of SKEMs, sign each of them, and publish them one by one in the log.

In an alternative embodiment, Bob signs and publishes a commitment relating to a set of SKEMs rather than signing each SKEM and publishing them one by one. An example commitment relating to a set of SKEMs may be the root value of a Merkle tree which stores the set of SKEMs, although other structures, such as hash chains, may be used as the basis for the commitment.

An SKEM can be used once or multiple times. In a secure communication protocol according to the present disclosure, the sender, i.e. Alice, randomly selects a path of the tree T′ such the digest of T′ is recorded in the rightmost leaf of another tree (as described in FIG. 6). So, each SKEM can be used a number of times according to the random selection by senders. Bob can generate as many SKEM as he wants. By generating a large number he increases the chance that an SKEM is used only once, which is more secure as can be understood from the description that follows.

In more detail, the public log in this scenario stores [hᵢ′, Nᵢ′, Pᵢ, σᵢ]_{i=1, . . . N}, where Nᵢ′ is the size of another Merkle tree T′ represented by its root hash value hᵢ′, Pᵢ is some public data, and σᵢ is a signature on (i, hᵢ′, Nᵢ′, Pᵢ). T′ comprises one or more commitments of generated key establishment messages, which can be used with another part of a key establishment message to generate an entire symmetric key. More precisely, each leaf of T′ is labelled by (the commitment of) the symmetric key establishment message (SKEM). In the example setting of the Diffie-Hellman key establishment protocol, the SKEM should be (p, q, g, g^{x}modp), where x is a random number in [1, q−1]. Note that in this example, if all leaves of T′ share the same public parameters (i.e. (p, q, g)), then we could put the shared parameter (p, q, g) into P rather than include it in every leaf of T′. If there are different public parameters, then P is null. FIG. 6 shows an example of the log, wherein P=(p, q, g); σ is a signature on (i, h′, N′, P), where i is according to dᵢ, so i=4 in this example; for all jε[1, 4], dⱼ′=g^{(x}^{ⱼ}⁾mod p for some random number xⱼε[1, q−1]. The log contains d₁, d₂, d₃, d₄, organised as Merkle tree T and represented by h. In which, d₄=(h′, N′, P, σ) such that h′ is the root hash value of another Merkle tree T′ that stores d′₁, d′₂, d′₃, d′₄, and N′ is the size of T′, P is the public parameters shared among d′₁, d′₂, d′₃, d′₄. For all i∈[1, 4], each (d′ᵢ, P) is an SKEM.

We assume that Bob has stored a previous version of his log log B_{B} of size N_{B} and identity LID_{B}, a sequence keyB of Diffie-Hellman secrets (i.e. the secret for symmetric key establishment), and a Merkle tree TB_{B} which stores public parts of KeyB, and a signature σ from the log maintainer in the previous session. In addition, we assume that the log maintainer also has her copy log B_{L} of Bob's log B_{B} and TB_{L} of TB_{B}. The size of log B_{L} is denoted N_{L}.

FIG. 7 illustrates a protocol for updating a log. This protocol enables Bob to update the pre-generated symmetric key establishment message (SKEM) recorded in the log. Each SKEM contains some public parameters (i.e. p, q, g) and a public key g^{b}modp for some random b∈[1, q−1]. The SKEM will be fetched later (in the secure communication phase) by Alice to build a symmetric key for secure communications with Bob. If any of the stated verification fails, the agent aborts the protocol.

To update log B_{L}, Bob generates a sequence KeyB′=(b₁, . . . , bₙ) of Diffie-Hellman secrets, and creates a Merkle tree TB′_{B} by using Create(g(^{b}^{₁}⁾, . . . , g^{(b}^{ₙ}⁾). Note that for all i∈[1, n], bᵢ is a random number in [1, q−1], and all computations should be module p, but we omit it to simplify the description. Now Bob sends (req_{U}, LID_{B}, m₁, σ₁) to the log maintainer, where req_{U} is the update request, m₁=(p, q, g, (g^{(b}^{₁}⁾, . . . , g^{(b}^{ₙ}⁾)) and σ₁=Sign((N_{B}+1, d), sk_{B}), where d=(Root(TB′_{B}), n, (p, q, g)). Note that we have n=Size(TB′_{B}).

After receiving the request, the log maintainer builds Merkle tree TB′_{L}=Create(g^{b}^{₁}, . . . , g^{b}^{ₙ}), gets n′=Size(TB′_{L}) and h′=Root(TB′_{L}), then verifies whether σₗ is a valid signature on (N_{L}+1, h′, n′, p, q, g) signed by Bob. If the signature is valid and (N_{L}+1, h′, n′, p, q, g) is signed by Bob, then the log maintainer updates the log log B_{L} by letting log B_{L}=Append(log B_{L}, (h′, n′, p, q, g, σ₁), replaces N_{L} with Size(log B_{L}), TB_{L} with TB′_{L}, stores (m₁, σ₁) in her database DB, and sends (m₂, σ₂)to Bob as the evidence of success update, where m₂=Root(Log B_{L}) and σ₂=Sign((m₂, LID_{B}), sk_{L}).

Bob should check if m₂=Root(Append(log B_{B}, (d, σ₁))), and verify the validity of σ₂. If the check is successful and the signature is valid, then Bob updates his record of the log by letting log B_{B}=Append(log B_{B}, (d, σ₁)), replaces N_{B} with Size(log B_{B}), keyB with keyB′ and TB_{B} with TB′_{B}, and stores σ₂.

In a manner similar to the first scenario, the protocol may be aborted if the validations or checks carried out by any party fail, with suitably informative error messages being sent back to Alice and/or to Bob.

If Alice wants to send a private message to Bob, she needs to start the protocol to query the

Bob's key establishment message by sending a request message (req_{Q}, ID_{B}, r) to the log maintainer, where r is a random number. We assume that Alice has stored Bob's log identity LID_{B}, a hash value h_{A}, an integer N_{A}, and a signature σ_{A}=Sign((LID_{B}, h_{A}, N_{A}, r_{A}), sk_{L}) obtained from the log maintainer in the previous session. Intuitively, h_{A}and N_{A} are respectively the root value and the size of Bob's log provided by the log maintainer in the last session, and r_{A} is a random number used also in the last session. The protocol of fetching an SKEM is presented in FIG. 8.

The log maintainer first locates and obtains the newest update (d, σ) in the log B_{L} by running Last(log B_{L}), where d=(Root(TB_{L}′), Size(TB_{L}′), p, q, g) and σ=Sign(N_{L}, (Root(TB_{L}′), Size(TB_{L}′), p, q, g), sk_{B}), then generates a proof Prf₁ that the leaf containing Last(log B_{L}) with path w is in the log B_{L}, and sends (m₁, σ₁) to Alice, where m₁=(d, σ, Prf₁, Root(log B_{L}), N_{L}) and σ₁=Sign((LID_{B}, Root(log B_{L}), N_{L}, r), sk_{L}).

After receiving the message, Alice verifies the validity of σ₁, the validity of σ such that it is a signature on (N_{L}, (Root(TB_{L}′), Size(TB_{L}′), p, q, g)) signed by Bob, and the validity of Prf₁ such that Last(log B_{L}) is in log B_{L} and the corresponding path w is the valid path of the rightmost leaf in a Merkle tree of size Size(log B_{L}). If they all valid, Alice picks a random path w′ such that w′ is the valid path of a leaf in the Merkle tree of size Size(TB_{L}′), and sends (w′, h_{A}, N_{A}) to the log maintainer.

Upon receiving the message, the log maintainer generates the proof (denoted Prf₂) that log B_{L} is an extension of the log represented by h_{A}, gets g^{(b}^{_{(n′)}}⁾ in TB_{L}′ according to the w′ specified by Alice, and generates the proof (denoted Prf₃) that g^{(b}^{_{(n′)}}⁾ is in the TB_{L}′ such that the path of the node storing g^{(b}^{_{(n′)}}⁾ is w′, then sends (m₂, σ₂) to Alice, where m₂=(g^{(b}^{_{(n′)}}⁾, Prf₂, Prf₃) and σ₂=sign(m₂, sk_{L}).

Alice should verify σ₂, Prf₂, and Prf₃ such that g^{(b}^{_{(n′)}}⁾ with path w′ is in the Merkle tree represented by Root(TB_{L}′). If they all valid, then Alice replaces h_{A} with Root(log B_{L}), replaces N_{A} with N_{L}, and replaces σ_{A} with σ₁.

Now, Alice can generate a random number a∈[1, q−1], and encrypt message m by using symmetric key k=kdf((g^{(b}^{ₙ}^{′)})^{a}), then send (w′, g^{a}, {m}ₖ) to Bob who can find b_{(n′)} in keyB according to w′, reconstruct k=kdf((g^{a})^{(b}^{_{n′}}⁾), and decrypt {m}ₖ. Now, both Alice and Bob can continue this session by using the shared symmetric key k.

The log may be monitored with a process similar to that outlined above for the aspect of online communication.

The embodiments above assume that the recipient owns a public/private key pair. However the technique works for any secret key of a recipient. For example, the secret key could instead be a symmetric secret key (SSK) shared between communication parties, e.g. Alice and Bob. If a symmetric key is used (instead of using the public/private key pair) and shared between Alice and Bob, then Bob may use the symmetric key SSK to make a symmetric-key signature on the information about the established symmetric key (ESK), and publishes information about them in the log. Alice can verify the published information by using the shared SSK.

Any way that can be used to authenticate and verify the information binding between a symmetric key and some data can be used to sign the data. There are variety ways to do so, for example, to authenticate and verify the binding between data D and a symmetric key SSK, one can use symmetric key encryption to encrypt D by using secret key SSK, or use hash-based message authentication code (HMAC) where in which SSK is the secret key and data D is the message to be authenticated.

The protocols described thus far consider the scenario of monitoring the usage of a single user's signing key. When there are multiple users with keys, an individual log may be provided for each user's key. However if there are a large number of keys this can become problematic.

For example, users would need to store n data for n different contacts, and it would be hard to run the gossip protocol to check n different log values.

However, according to the present disclosure a single log may be provided which can monitor the usage of multiple keys, and furthermore can monitor usage of a large number of keys.

These techniques apply to either the online or offline aspects described above, although for purposes of illustration the technique will be explained with respect to the offline aspect.

According to an embodiment of a log for monitoring multiple keys, the log may comprise two data structures. When the log is updated, data may be stored in both data structures. A first data structure comprises an ordered tree such as a Merkle tree, in which items are stored only in the leaves and ordered chronologically. The second data structure is also an ordered tree such as a Merkle tree, in which the items are stored in the leaves but ordered according to some attribute of the item. For example, items can be ordered lexicographically according to the user identifier. FIG. 9 shows an example of a data structure according to this embodiment. Here, for all a, b∈[1, 257], h(a, b) is the root hash value of a Merkle tree containing data from dₐ to d_{b}. For example, h(1,257)=h(h_{(1,256)}, d₂₅₇). The first data structure (Merkle tree T) contains D₁, D₂, D₃, D₄, such that for all 1≦k<j≦4, Dₖ is chronologically smaller than Dⱼ (i.e. Dₖ was appended prior to appending Dⱼ); the second data structure (Merkle tree Tᵢ′) contains d₁, d₂, . . . , d₂₅₇, such that for all 1≦k<j≦257, the chosen attribute (e.g. user identity) of dₖ is lexicographically smaller than the chosen attribute of dⱼ.

We will call the log initialisation protocol described above the ‘single-user-log-reg’; we call T the instance of the first data structure; and we call T₁′ the first instance of the second data structure created by the log maintainer.

In the case that the usage of multiple keys needs to be monitored, the log maintainer builds T as a single log. After the log maintainer runs the ‘single-user-log-reg’ with each of the users (in a specified time period), the log maintainer records all requests ((req, ID, nonce), σ) received in the protocol run of ‘single-user-log-reg’ in T₁′ with their corresponding user identity, and records the digest of T₁′ in T. As an example and as shown in FIG. 9, the digest of Tᵢ′ can be the pair of tree root hash value (i.e. h_{(1,257)}) and tree size (i.e. 257).

Each of the users should verify the proof that their user identity with their request is present in T₁′, and the digest of T₁′ is recorded in T. Users should store the digest of T locally for performing further verification and for gossiping with other users to check the unicity of the log.

The log maintainer periodically creates a new instance of the second data structure to record new updates, and records the digest of the new tree into T.

Let N be the size of T. By the end of the current (N^{th})) update period, the log maintainer creates T_{N+1}′ to record all users' identity with their latest data. In this example, the data is (h′, n′, p, q, g, σ₁) as described above in the log update method of the offline aspect. The log maintainer then appends the digest of T_{N+1}′ into T. As shown in FIG. 9, if Tᵢ′ is the tree for recording new changes, then this update contains the data associated to 257 users, and the digest of Tᵢ′ will be appended in T as the record of the fifth update.

Each of the users should verify that (ID, (h′, n′, p, q, g, σ₁)) is in Tᵢ′ and that the digest of Tᵢ′ is in T, and additionally verify the proof that the current T of size N+1 is an extension of the previous digest that the user stored.

We assume that Alice wants to send a message privately to Bob. The process may be described as follows:
Alice sends a request to the log maintainer with Bob's identity (ID_{B}) and a random number r;
the log maintainer signs r, the digest of T, together with the proof that the digest of the T_{N}′ is stored in the last leaf of T, where N is the size of T; and the proof that ID_{B} with the digest (h′, n′) (as presented in FIG. 7) of Bob's Merkle tree TB_{B}′ that was created by using Create(g^{(b}^{₁}⁾, . . . , g^{(b}^{ₙ}⁾) is in T_{N}′; then sends them to Alice.
After verifying all received signatures and proofs, Alice picks a random path according to the size n′ of Bob's TB_{B}′ that stores the set of SKEMs, and sends the picked path and the previous stored digest of T to the log maintainer.
The log maintainer generates the proof that T is extended from the Merkle tree represented by the digest that Alice previously stored; and gets the key exchange material according to the path selected by Alice, and generates the proof that this key exchange material is in Bob's Merkle tree TB_{B}′, and signs and sends these data to Alice.
Alice verifies all received proofs and signatures, and replaces the previous stored digest by the current digest of T.
Now, Alice can establish a symmetric key and have secure communications with Bob in a similar way as used in the previous embodiment.

Key owners should monitor whether the data containing their identity and a digest stored in each Tᵢ′ is representing the same set of data as they generated and uploaded.

All users can run a gossip protocol to verify whether the digest they stored is the same as, or a previous or subsequent snapshot of, what other users stored.

Additionally, each of the users may randomly select some leaves of Tᵢ′. If the size of Tᵢ′ is N′, then we assume that each of the selected leaves is the k^{th} leaf for some k∈[1, N′]. Then, for each such k, the user verifies the proof that the (k−1)^{th} leaf is lexicographically smaller than the k^{th} leaf, if applicable. This randomized verification can be used to verify that items in the Tᵢ′ are stored in the correct order, and it does not need to be verified in each communication.

FIG. 10 is a diagram illustrating an embodiment of a system according to the disclosure, which may be suitable for implementing any of the embodiments disclosed thus far. Here, the actors in the system comprise a recipient 1000, a log 1002 (which may be controlled by a log maintainer) and a sender 1004. The recipient 1000 owns a secret key 1006 which is used as mentioned above. In this embodiment the recipient 1000, log 1002 and sender 1004 are all separate computers and they communicate with each other by any suitable means, such as internet connections. Each of the actors executes an application 1008, 1010, 1012 that causes the computers to implement a protocol for the methods described above. The applications 1008, 1010, 1012 may be provided as any form of computer program product, and they may be the same application (with the different actors using the application for their own individual roles), or they may be dedicated role-specific applications.

The disclosure is not meant to be to any particular architecture, and it will be appreciated that the recipient, sender and log may be provided on separate computers or on the same computer, and that the application(s) for implementing the protocols may be provided on each computer separately, or as a hosted service.

The techniques of the disclosure can be used with any application of public key infrastructure and any application that uses a shared secret key. Examples include secure electronic messaging systems. If applied with a secure email system (e.g. PGP, S/MIME), then the resulting system can detect the unauthorized usage of secret keys.

Identity based cryptography is another example of a possible application. A known drawback of identity based encryption is key escrow, i.e. the identity provider has a copy of everyone's private key. This disclosure solves this problem by allowing individuals to detect if the identity provider uses those keys.

The disclosure can also be applied on the TLS protocol to detect compromise of the secret key of domain servers.

The disclosure can also be applied on app-to-server applications where secure communications are expected between two parties (e.g. between a service provider and a customer, and between two customers). Again, the resulting system can detect compromise of the secret key of application server and/or customer.

Various improvements and modifications can be made to the above without departing from the scope of the disclosure.

It is also to be understood that the disclosure allows for a sender to send a message to multiple recipients simultaneously.

1. A method for a recipient of an encrypted message to detect usage of a first key belonging to the recipient wherein:
a sender and the recipient establish a second key using the first key;
the recipient publishes a commitment relating to the second key in a log;
the sender verifies the published commitment; and
the recipient monitors the log to detect usage of the first key.

2. The method of claim 1, wherein the published commitment comprises a commitment of the recipient's key exchange contribution to the second key, a commitment of the sender's key exchange contribution to the second key, or a commitment of the second key.

3. The method of claim 1, wherein the recipient maintains his own record of the log and compares the log with his own record.

4. The method of claim 1, wherein the recipient has a key pair comprising the first key and a third key and according to the method:
the recipient commits to information relating to the second key with his first key; and
the sender uses the third key to verify the commitment of the recipient on the committed information.

5. The method of claim 4, wherein the recipient's commitment of information relating to the second key comprises a digital signature or other proof of knowledge.

6. The method of claim 4, wherein the information relating to the second key committed by the recipient comprises one or more of: the recipient's key exchange contribution to the second key or a commitment thereof, a commitment of the second key, the sender's key exchange contribution to the second key or a commitment thereof.

7. The method of claim 1, wherein the first key is a secret key.

8. The method of claim 1, wherein the first key is a symmetric key shared between sender and recipient, and according to the method:
the recipient authenticates information related to the second key with the first key; and
the sender uses the first key to verify the authenticity of the information.

9. The method of claim 1, wherein parties comprising one or more recipients and one or more senders employ a gossip protocol to verify that the parties are being shown the same version of the log.

10. The method of claim 1, wherein the recipient generates a set of key establishment messages, and (a) commits to each of them, and publishes them in the log, or (b) commits to information relating to the set of key establishment messages and publishes the commitment in the log.

11. The method of claim 1, wherein the second key is an encryption key or a verification key.

12. The method of claim 1, wherein the log is an append-only log.

13. The method of claim 12, wherein the log comprises a tree data structure.

14. The method of claim 13, wherein the log comprises a first tree data structure in which items are ordered chronologically and a second tree data structure in which items are ordered by an attribute of the items.

15. The method of claim 1, wherein the log is public.

16. The method of claim 15, wherein the addressable public who can access the log comprise a set of users who are provided with permissions to access the log, or comprises the general public.

17. The method of claim 1, wherein a single log is maintained for multiple users.

18. A method of exchanging an encrypted digital message between a sender and a recipient that holds a first key, wherein:
the sender and the recipient establish a second key using the first key;
the recipient publishes a commitment relating to the second key in a log;
the sender verifies the published commitment; and
the recipient monitors the log to detect usage of the first key.

19. A system comprising
a first key held by a recipient of an encrypted message;
a log; and
a computer program product comprising instructions that, when executed by a computer, implement a protocol for the recipient of an encrypted message to detect usage of the first key wherein, according to said protocol:
a sender and the recipient establish a second key using the first key,
the recipient publishes a commitment relating to the second key in a log,
the sender verifies the published commitment, and
the recipient monitors the log to detect usage of the first key.

20. A computer program product comprising instructions that when executed by a computer, enable the computer to act as a recipient of an encrypted message in the method of claim 1; a sender of an encrypted message in the method of claim 1; or a log in the method of claim 1.
